(19) United States
(12) Patent Application Publication
(10) Pub. No.: US 2024/0149732 A1
(43) Pub. Date: May 9, 2024

(54) CONTROL METHOD AND CONTROL UNIT FOR A CHARGING PROCESS FOR AN ELECTRIC VEHICLE

(71) Applicant: LEONI KABEL GMBH, Roth (DE)

(72) Inventor: SEBASTIAN GOSS, Roth (DE)

(21) Appl. No.: 18/280,579

(22) PCT Filed: Feb. 28, 2022
(86) PCT No.: PCT/EP2022/054907

§ 371 Date: Sep. 6, 2023

(30) Foreign Application Priority Data
Mar. 17, 2021 (DE) 10 2021 106 513.5

(51) Int. Cl. B60L 53/62; B60L 53/18; B60L 53/66; H02J 7/00

(52) U.S. Cl. CPC B60L 53/62; B60L 53/18; B60L 53/66; H02J 7/00309; H02J 7/007192

(57) ABSTRACT

A control unit (10) includes a first interface (14) by way of which the control unit (10) is able to be connected or is connected to a charging station (20). A processor (12) is designed to instruct the charging station (20) to charge an electric vehicle (40) with a charging current using a charging cable (30). An initial current value of the charging current is higher than a continuous current value associated with the charging cable (30). The processor (12) is also designed to ascertain whether a temperature linked to the charging cable (30) reaches or exceeds a maximum temperature value linked to the charging cable (30); and to instruct the charging station (20) to reduce the charging current if the temperature linked to the charging cable (30) reaches or exceeds the maximum temperature value.

### RELATED APPLICATIONS

This application filed under 35 U.S.C § 371 is a national phase application of International Application Number PCT/EP2022/054907, filed Feb. 28, 2022, which claims the benefit of German Application No. 10 2021 106 513.5 filed Mar. 17, 2021, the subject matter of which are incorporated herein by reference in their entirety.

### TECHNICAL FIELD

The invention relates to a method for controlling a charging process of electric vehicles, to an associated control unit for controlling a charging process of electric vehicles, and to a charging system having such a control unit.

### BACKGROUND

Electric vehicles are usually charged at charging stations by means of charging cables. Such charging cables are normally connected at one end to the charging station by way of a plug connection and for the charging process can be connected to an electric vehicle by way of a plug connection. The maximum charging capacity for charging an electric vehicle (e.g. an electric car) depends on multiple factors, such as, for example, the charging capacity of the electric vehicle, the charging station, and the charging cable.

Electric vehicles can be charged by means of alternating current (AC) (also by means of three-phase current as a specific form of alternating current) and/or direct current (DC). The current provided by way of the power network is always alternating current. In the case of alternating current charging, alternating current is transferred from the charging station by way of the charging cable into the vehicle and is converted in the vehicle into direct current in order to charge the vehicle battery. The AC charging capacity can vary according to the charging device that is installed. For example, some vehicles charge only at 3.7 Kw. Other vehicles can be charged at up to 22 Kw and thus significantly more quickly. In general, today's alternating current charging devices provide various ranges between 16 A (3.7 Kw) and 63 A (43 Kw). Alternating current charging is appropriate for charging a car at home or at work over several hours because of the length of time that is necessary. In the case of the charging of electric vehicles with direct current (direct current charging for short) in order to charge electric cars more quickly (rapid charging for short), AC is converted into DC outside the vehicle. The charging station then charges the battery of the electric car by way of the charging cable. The charging cable used must therefore be able to transmit direct current. So-called rapid charging stations permit high charging capacities of, for example, up to 50 Kw, up to 70 Kw or even up to 250 Kw—depending on the vehicle. DC charging stations and DC charging devices are often found close to motorways or at public charging stations where not much time is available for charging.

Apart from the electric vehicle and the charging station, there are further factors which influence the maximum charging capacity, such as, for example, the temperature and the charge level of the battery.

In addition to the temperature of the battery, the temperature of the charging cable is also a factor for the charging capacity and thus the duration of the charging process. In general, charging systems for a high charging capacity result in pronounced heating. Problems can occur in particular in the case of charging cables with relatively small cross sections. The relatively small cross sections would not normally be able to transmit the necessary power, because they would heat up too quickly as a result of the current load. This could lead to the maximum permissible conductor temperature according to EN 50620 or IEC 62893 being exceeded after a certain time. The charging process would have to be interrupted or terminated where possible. Furthermore, the lines are damaged in terms of their service life. Moreover, the surface temperature of the charging line could likewise rise above the limit value of IEC 117 and possibly result in injury to the user when touching/handling the charging cable. The thermal energy that occurs during charging is dissipated in the case of so-called cooled charging cables by means of a cooling line.

Hitherto, charging cables/charging lines have been subjected at the maximum to the current intensity which they are permanently able to withstand without exceeding the statutory limit temperatures. The statutory limit temperatures are, for example, 60° C. at or on the surface of a charging cable or 90° C. in the core of a charging cable. If a charging process is shorter than the heating time of the line, the line is effectively operated below its capacity. The technically available capacity of the line is not utilized fully.

EP 2 981 431 B1 relates to a method for operating a charging station for electric vehicles. In that method, a charging power between a charge control device of the electric vehicle and the charging station is calculated. The charge control device controls a charge current transmitted from the charging station to the electric vehicle according to the calculated charge power. A maximum power is greater than a continuous nominal power. A charging power which is above the continuous nominal power and corresponds at the maximum to the maximum power is first calculated. The temperature in the charging station is monitored. Depending on the temperature in the charging station, a new charging power is calculated. By monitoring the temperature in the charging station, damage to components within the charging station can be prevented. A more efficient charging process is not achieved to a sufficient degree.

DE 10 2017 209 450 A1 relates to a method for determining temperature information concerning a temperature of a charging interface. The charging interface is arranged on a current path between a charging station and an electrical energy store of a vehicle. Target information concerning a target charging power which is provided by the charging station on the current path is determined. Actual information concerning an actual charging power which is taken from the current path by the energy store is determined. Temperature information is determined on the basis of the target information and on the basis of the actual information. The target charging power is adapted in dependence on the temperature information. Thus, optionally without the use of a temperature sensor, the temperature of the charging interface can be determined and monitored. A more efficient charging process is not achieved to a sufficient degree.

DE 11 2010 005 561 T5 relates to a vehicle which is externally chargeable with electric power transmitted through a charging cable from an external power supply. The vehicle has a chargeable power storage device, a charging device for supplying the power storage device with charge power using the electric power transmitted from the external power supply, and a control device for controlling the charging device in order to limit the charge power based on a state of a power transmission path from the external power supply to the charging device. A more efficient charging process is not achieved to a sufficient degree.

There is therefore a need to better utilize the available capacity of charging cables. To this end, a method for controlling a charging process, a control unit for controlling a charging process, and a charging system having such a control unit are proposed.

### SUMMARY OF THE INVENTION

According to a first aspect of the invention, a method for controlling a charging process of electric vehicles is proposed. The method comprises instructing a charging station to charge the electric vehicle by way of a charging cable with a charging current. An initial current value of the charging current is above a continuous current value attributed to the charging cable. The method comprises determining whether a temperature associated with the charging cable reaches or exceeds a maximum temperature value associated with the charging cable. The method comprises instructing the charging station to reduce the charging current if the temperature associated with the charging cable reaches or exceeds the maximum temperature value.

The continuous current value (value of the continuous current) can be determined by the component of the charging cable or the element associated with the charging cable that heats up the most and thus constitutes the greatest risk potential for a thermal overload. The continuous current can be the current with which the charging cable can permanently be operated and nevertheless complies with the statutory safety provisions. For example, charging lines can be subjected at the maximum to the current intensity which they are permanently able to withstand without exceeding the statutory limit temperatures. The statutory limit temperatures for a charging cable can be 60° C. at or on the surface of the charging cable and/or 90° C. in the core of the charging cable. However, a load above the continuous current is possible for a short time without the component(s) in question being damaged. The possible duration of this overload depends on various factors.

The continuous current value attributed to the cable can be a value of a current with which the charging cable can or may be permanently operated. In this context, attributed can be understood as meaning that the continuous current value in question applies to the corresponding charging cable. The continuous current value of the charging cable in question can be known beforehand or can be determined beforehand.

The temperature associated with the charging cable can be a temperature of the charging cable and/or a temperature of at least one plug connector of the charging cable. For example, the temperature associated with the charging cable can be or include a temperature of the charging cable. According to conceivable embodiments, the temperature of the charging cable can be or include a temperature in the interior, for example in the core, of the charging cable and/or can be or include a temperature at the surface of the charging cable. For example, the temperature associated with the charging cable can be or include a temperature of at least one electrical line of the charging cable provided for conducting electric current. According to conceivable embodiments, the temperature of the charging cable can be or include a temperature in the interior, for example in the core, of the at least one electrical line of the charging cable and/or can be or include a temperature at the surface of the at least one electrical line of the charging cable.

For example, the temperature associated with the charging cable can be a temperature of components of the charging cable and/or a temperature of components of at least one plug connector of the charging cable. For example, it can be a temperature of a first plug connector, or of components of the first plug connector, by way of which the charging cable can be connected to the charging station, and/or a temperature of a second plug connector, or of components of the second plug connector, by way of which the charging cable can be connected to the electric vehicle.

The maximum temperature value associated with the charging cable can be dependent on various factors. The maximum temperature value associated with the charging cable can be a maximum temperature value of the charging cable or can include a maximum temperature value of the charging cable. For example, the maximum temperature value can depend on the location for or at which the temperature associated with the charging cable is determined. For example, the maximum temperature value can be higher if a core temperature of the charging cable is monitored as the temperature value to be maintained than in a case where a surface temperature of the charging cable is monitored as the temperature value to be maintained. For example, the maximum temperature value of the core can be 90° C. For example, the maximum temperature value of the surface can be 60° C. The maximum temperature value associated with the charging cable can be a maximum temperature value of at least one plug connector of the charging cable or can include a maximum temperature value of at least one plug connector of the charging cable.

Plug connectors (in particular direct current (DC) contacts of the plug connector) can heat up relatively quickly, for example more quickly than the charging cable or the electrical lines of the charging cable. There are some plug connectors which can be subjected to higher temperatures or which withstand or tolerate higher temperatures than charging cables. For example, in the case of charging processes at 240 A, a cooled charging line can have a surface temperature of 35° C., whereas a DC contact in the plug connector/plug/inlet reaches 80° C. It is further conceivable that the DC contact(s) of the plug connector are actively cooled and consequently reach lower temperatures during a charging process than the charging cable, in particular if the charging cable is not actively cooled.

As described above, charging cables/charging lines have hitherto been subjected at the maximum to the current intensity which they are permanently able to withstand without exceeding the statutory limit temperatures (of, for example, 60° C. at the surface and/or 90° C. in the core). If a charging process is shorter than the heating time of the line, the line is effectively operated below its capacity. A process of heating a line from room temperature to a surface temperature of 60° C. can take up to 30 minutes. This heating time is defined by the PTC thermistor properties of the conductor and/or conductor material used, for example copper, and the thermal capacity of the cable materials. As a concrete example, an uncooled DC charging line of cross section 2×70 mm² can heat up for up to 1.5 hours at rated current before thermal inertia occurs.

Conversely, this heating time means that the maximum charging current which was determined for continuous operation of, for example, longer than 30 minutes is initially too low or could be higher without exceeding the statutory temperature specifications. This maximum charging current is also referred to herein as the continuous current or maximum permissible continuous current or continuous nominal current or maximum permissible continuous nominal current. In order to increase the amount of energy that is transmitted specifically in the case of charging processes of short duration of up to and including 20 minutes, it would thus be advantageous to subject the lines to a current which is greater than the maximum permissible continuous current.

In the method according to the first aspect, it can repeatedly, for example continually or continuously or permanently, be determined during the charging process whether a temperature associated with the charging cable reaches or exceeds a maximum temperature value associated with the charging cable. Accordingly, it can repeatedly, for example continually or continuously or permanently, be checked during the charging process whether the charging current is to be reduced or must be reduced (if the temperature associated with the charging cable reaches or exceeds the maximum temperature value).

In the method according to the first aspect, the initial current value of the charging current is above a continuous current value/value of the continuous current attributed to the charging cable. The capacity of the charging cable is therefore utilized more efficiently. The electric vehicle can be charged more efficiently and/or more quickly. In other words, an energy storage device, for example a battery, of an electric vehicle can be charged more efficiently and/or more quickly. To put it another way, a desired or full charging capacity (or capacity for short) of a battery of the electric vehicle can be reached more quickly.

The capacity of a battery can refer to the ability of a fully charged battery to deliver a specific amount of electricity (measured in ampere-hours (Ah)) with a specific intensity (in amperes (A)) over a specific time (in hours (h)). The unit for the electrical charging capacity of a battery is therefore usually Ah. It is calculated by multiplying the current intensity (in amperes (A)) by the time (in hours (h)) for which a battery delivers current before It is discharged. Example: a battery which delivers current of 5 amperes for 20 hours has a charging capacity of 100 ampere-hours (20 h×5 A=100 Ah). Alternatively, the amount of energy in kWh is often used and referred to as the capacity of a battery.

In the method according to the first aspect, the charging station is instructed to reduce the charging current if the temperature associated with the charging cable reaches or exceeds the maximum temperature value. By reducing the charging current if the temperature associated with the charging cable exceeds the maximum temperature value, it is ensured that the statutory temperature provisions are complied with and/or components associated with the charging cable are not adversely affected or damaged. The components associated with the charging cable can be components of the charging cable and/or components of at least one plug connector of the charging cable. For example, they can be components of a first plug connector by way of which the charging cable can be connected to the charging station, and/or components of a second plug connector by way of which the charging cable can be connected to the electric vehicle.

The method can further comprise instructing the charging station to reduce the charging current to a value corresponding at the maximum to the continuous current or at least almost exactly to the continuous current if the temperature associated with the charging cable exceeds the maximum temperature value. By reducing/lowering the charging current to a value which corresponds at the maximum to the continuous current, for example is below the continuous current, or which corresponds at least almost exactly to the continuous current, it is ensured that the statutory temperature provisions are complied with and/or the components associated with the charging cable are not adversely affected or damaged.

The method can further comprise instructing the charging station to maintain the charging current at a value above the continuous current, for example at the current value that is currently being used, if the temperature associated with the charging cable does not exceed the maximum temperature value. Because the value of the charging current is above a continuous current value attributed to the charging cable, the capacity of the charging cable is utilized more efficiently. The charging process can thus be accelerated and/or made more efficient. Because the temperature associated with the charging cable does not exceed the maximum temperature value, it is at the same time ensured that statutory temperature provisions are complied with. This likewise has the effect that the components associated with the charging cable are not adversely affected or damaged.

The method can further comprise receiving information relating to a capacity to be charged of a battery to be charged and determining an initial current value of the charging current taking account of the capacity of the battery to be charged. For example, the initial current value can be chosen in dependence on the capacity of the battery to be charged or in dependence on the capacity to be charged of the battery to be charged. According to one example, the battery is to be charged fully. For example, a user chooses or a vehicle or a higher-level entity determines that the battery is to be charged fully. According to this example, the missing capacity of the battery until it is fully charged is used to determine the initial current value. According to a further example, the battery is to be partially charged. For example, the capacity to which the battery is to be partially charged is chosen beforehand by a user or determined by a vehicle or a higher-level entity. The initial current value can be determined on the basis of the capacity of the battery to be charged. For example, the higher the capacity to be charged, the higher the determined initial current value.

The method can further comprise receiving information relating to a time period for at least partial charging of a battery to be charged and determining an initial current value of the charging current taking account of the time period for charging of the battery to be charged. For example, it is conceivable that the information relating to the time period is determined automatically or inputted manually. The time period can be a fixed or unchangeable time period for the charging process. According to one example, the information relating to the time period can be determined automatically by the charging station and/or by the electric vehicle and/or by a control unit and/or by a higher-level entity. The determined information can, for example, be manually adjusted by a user. According to a further example, the information relating to the time period can be inputted manually by a user, for example by way of a portable terminal device or at the charging station or into the vehicle.

The initial current value can be determined on the basis of the time period. In this way, an initial current value can be determined, for example, before the start of the charging process on the basis of a preselected time. The cable and/or plug connector temperature can be monitored during the charging process. In this way, an optimized charging process can be started and carried out, which can transmit more energy without exceeding the statutory temperature provisions (for example 60° C. at the surface; 90° C. in the core). For example, the shorter the time period, the higher the determined initial current value. The shorter the available time period, the higher the ideal initial current value which can be chosen, with which maximum possible charging of the battery is achieved. The shorter the time period, the shorter the time in which the components associated with the charging cable can heat up. In this case, it is not necessary, or optionally necessary for only a short time, to reduce the charging current. The longer the time period, the longer the time in which the components associated with the charging cable can heat up. In this case, it may be more expedient to choose a middle initial starting value, with which charging can be carried out for longer before the temperature limit value is reached, rather than to choose a high initial current value with which charging may be able to be carried out for only a short time before the temperature limit value is reached. In conjunction with a preselected time before the start of the charging process, an optimum power yield can thus be achieved. By inputting or automatically determining a parameter “charging time” and reading out the “line temperature” and/or “plug temperature”, an optimal current feed can be chosen or determined, which is initially significantly greater than the continuous current carrying capacity of the line. More energy is thus transmitted.

According to a second aspect of the invention, a control unit for controlling a charging process of electric vehicles is proposed. The control unit has a first interface and a processor. The control unit is able to be connected or is connected by way of the first interface to a charging station. The processor is configured to instruct the charging station to charge the electric vehicle by way of a charging cable with a charging current. The initial current value of the charging current is above a continuous current value attributed to the charging cable. The processor is configured to determine whether a temperature associated with the charging cable reaches or exceeds a maximum temperature value associated with the charging cable. The processor is configured to instruct the charging station to reduce the charging current if the temperature associated with the charging cable reaches or exceeds the maximum temperature value.

The control unit can further have a second interface. The second interface can be formed separately from the first interface or in a common interface unit. The second interface can be different from the first interface or can correspond to the first interface. The second interface can be configured to receive or to determine the temperature associated with the charging cable. There can be determined as the temperature associated with the charging cable, for example, a temperature of the charging cable or inside the charging cable and/or a temperature of a plug connector of the charging cable. The temperature of the charging cable or the temperature in the charging cable can be determined by measuring a temperature of the charging cable or in the charging cable. The measured value can then, for example, be transmitted to the second interface or received by the second interface. The temperature of the charging cable (e.g. at the surface of the charging cable) or in the charging cable can alternatively also be calculated from other, for example measured, parameters. The temperature of a plug connector of the charging cable or in a plug connector of the charging cable can be measured or calculated from measured parameters. The measured parameters can, for example, be transmitted to the second interface or received by the second interface. The processor can determine or calculate the temperature associated with the charging cable from the parameters.

The processor is further configured to instruct the charging station to reduce the charging current to a value corresponding at the maximum to the continuous current if the temperature associated with the charging cable reaches or exceeds the maximum temperature value. By reducing/lowering the charging current to a value which corresponds at the maximum to the continuous current, for example is below the continuous current, or which corresponds exactly to the continuous current, it is ensured that the statutory provisions and safety provisions are complied with and/or the components associated with the charging cable are not adversely affected or damaged.

The processor can further be configured to instruct the charging station to hold or maintain the charging current at a value above the continuous current if the temperature associated with the charging cable does not exceed the maximum temperature value. Because the value of the charging current is above a continuous current value attributed to the charging cable, the capacity of the charging cable is utilized more efficiently. The charging process can thus be accelerated and/or made more efficient. Because the temperature associated with the charging cable does not exceed the maximum temperature value, it is at the same time ensured that statutory temperature provisions are complied with. This likewise has the effect that the components associated with the charging cable are not adversely affected or damaged.

The control unit can further have a third interface. The third interface can be formed separately from the first and/or second interface or in a common interface unit with the first and/or second interface. The third interface can be different from the first and/or second interface or can correspond to the first and/or second interface.

The third interface can be configured to receive information relating to a capacity to be charged of a battery to be charged. The processor can further be configured to determine an initial current value of the charging current taking account of the capacity of the battery to be charged. In addition or alternatively, the third interface can be configured to receive information relating to a time period for the at least partial charging of a battery to be charged. The processor can be configured to determine an initial current value of the charging current taking account of the time period for the charging of the battery to be charged.

According to a third aspect, a charging system for an electric vehicle is proposed. The charging system has a charging station, a charging cable by way of which the charging station is able to be connected or is connected to the electric vehicle, and a control unit as described herein.

The charging cable can be a cooled or uncooled charging cable. The charging cable can have at least one electrical conductor (at least one electrical line), for example multiple electrical conductors. The at least one electrical conductor can be in the form of, for example, a copper conductor. Owing to the high electrical conductivity of copper, the charging capacity of the charging cable can be high when the at least one electrical conductor is in the form of a copper conductor.

The charging cable is in the form of, for example, a charging cable for electric vehicles. The charging cable can be in the form of a direct current charging cable and/or in the form of an alternating current charging cable. The charging cable can have one or more conductors or one or more wires for charging with alternating current (alternating current conductors for short). By means of the one or more conductors for alternating current, the charging cable can be used for the alternating current charging of an electric vehicle. For example, the charging cable can be a combination cable with which both direct current and alternating current charging is possible. The advantages described herein can be particularly great in particular in relation to direct current charging cables for/with a high charging current, for example owing to the relatively large diameter and the associated higher thermal capacity of such a charging cable compared optionally to alternating current charging cables. Owing to optionally the smaller diameter of alternating current cables/lines and the associated lower thermal capacity of the lines, the effect may be smaller in the case of alternating current lines.

The temperature of the charging cable or the temperature in the charging cable can be determined by measuring a temperature of the charging cable or in the charging cable. The charging cable can have at least one sensor. The at least one sensor can be in the form of a temperature sensor. The temperature sensor is configured to detect the temperature of the charging cable. The temperature sensor can be in the form of a sensor wire which has been inserted into the charging cable, for example in the form of a sensor wire which has been stranded into or stranded with the charging cable or stranded with at least one electrical line of the charging cable.

The charging cable can further have at least one second sensor. The at least one second sensor can be configured to monitor a state of the charging cable and to communicate said state to a user by way of an evaluation unit.

In one exemplary embodiment, the charging cable can have at least two sensors. At least one of the at least two sensors can be in the form of a temperature sensor. The temperature sensor is configured to detect the temperature of the charging cable. The temperature sensor can be in the form of a sensor wire which has been inserted into the charging cable. For example, the temperature sensor in the form of a sensor wire can be/have been braided into or braided with the charging cable. By means of the temperature sensor It is possible in a simple manner to determine and optionally monitor whether the charging cable is in an appropriate temperature range. For example, the charging cable can be monitored by means of the temperature sensor for overheating. The inserted sensor wire can be/have been braided in a flexible manner into the line, so that the line is not damaged thereby.

The temperature sensor and/or the at least one second sensor can be in the form of a resistor-based sector sensor. The at least one second sensor can be a sensor for measuring at least one further parameter other than the temperature. For example, the charging cable can have or be in the form of at least one sensor cable (at least one line) for measuring the temperature and at least one further parameter.

The charging cable and in particular the at least two sensors can be connected, for example wirelessly and/or by wire, to an evaluation unit. The evaluation unit can be, for example, an external evaluation unit or an evaluation unit which is present in the control unit or which is able to be connected or is connected to the control unit. The evaluation unit can, for example, be connected to the charging cable by way of a cloud or it can be in the form of a cloud. The evaluation unit can be configured to evaluate data acquired from the charging cable. The evaluation unit can be configured, in dependence on the evaluated data, to warn of and optionally respond to a possible failure. The evaluation unit can be, for example, an external or internal component of the control unit.

As an alternative to a temperature sensor, the temperature associated with the charging cable, for example the temperature of the charging cable, can be determined by means of other configurations. As a first possible configuration, a voltage drop of the power wire of the charging cable can be used for the temperature determination in the case of uncooled lines. For example, a mean value along the line can be used for this purpose. Although this is only an approximation, it may be sufficient for the chosen purpose. As a second possible configuration, in the case of cooled lines a temperature delta/temperature difference between the feed and return of the cooling can be used in order to determine the temperature development and/or the temperature that is present. This type of temperature determination can optionally also be combined with the first possible configuration. In addition or alternatively, one or more discrete sensors on/in the line can be used for one or more single-point measurements.

Although some of the aspects described above have been described in relation to the method according to the first aspect, these aspects can also be implemented in a corresponding manner in the control unit according to the second aspect and/or in the charging system according to the third aspect, and vice versa.

### BRIEF DESCRIPTION OF THE DRAWINGS

The present invention will be explained further by means of figures. These figures show, schematically:

FIG. 1a an exemplary embodiment of a control unit for controlling a charging process;

FIG. 1b an exemplary embodiment of a charging system having a control unit for controlling a charging process according to FIG. 1a;

FIG. 2 an exemplary embodiment of a method for controlling a charging process;

FIG. 3a a profile of different charging currents in the case of the use of a control unit according to FIG. 1a and/or of a method according to FIG. 2;

FIG. 3b the profile of different charging currents from FIG. 3a together with an illustration of the capacity achieved in each case;

FIG. 3c a profile of capacities which are achievable by means of different charging currents in the case of the use of a control unit according to FIG. 1a and/or of a method according to FIG. 2;

FIG. 4 a profile of a charging current as well as possible temperature profiles in the case of the use of a control unit according to FIG. 1a and/or of a method according to FIG. 2;

FIG. 5a a profile of a charging current in the case of the use of a control unit according to FIG. 1a and/or of a method according to FIG. 2;

FIG. 5b a profile of a charging current in the case of the use of a control unit according to FIG. 1a and/or of a method according to FIG. 2;

FIG. 5c a profile of a charging current in the case of the use of a control unit according to FIG. 1a and/or of a method according to FIG. 2; and

FIG. 5d a profile of a charging current in the case of the use of a control unit according to FIG. 1a and/or of a method according to FIG. 2.

### DETAILED DESCRIPTION

In the following text, specific details are set out, without implying any limitation, in order to provide a complete understanding of the present invention. However, it will be clear to a person skilled in the art that the present invention can be used in other exemplary embodiments which may differ from the details set out hereinbelow.

Furthermore, the figures serve merely for the purpose of illustrating exemplary embodiments. They are not true to scale and are merely intended to reflect the general concept of the invention by way of example. For example, features which are contained in the figures are in no way to be considered a necessary constituent.

Where mention is made herein of the capacity (or charging capacity or storage capacity) of an energy storage device, for example of a rechargeable battery, this can be understood as meaning the total amount of electric charge or the total amount of electrical energy which the battery can deliver in operation before it must be replaced or recharged. The indicated capacity often refers to the electric charge, which in most cases is indicated in units of ampere-hours (Ah), or in smaller units such as milliampere-hours (mAh=0.001 Ah). For example, a car battery (starter battery) typically has a capacity of the order of from 50 to 100 Ah. This means that it can deliver, for example, an electrical current intensity of 1 A to a consumer for from 50 to 100 hours, or a higher current intensity for a correspondingly shorter time. The amount of energy delivered is frequently also of interest, because a battery ultimately serves as an energy store. This is obtained simply by multiplying the electric charge by the electric voltage. Ultimately, the voltage is nothing other than the energy per charge quantity. For example, a car battery which can deliver 50 Ah at a voltage of 12 V supplies an amount of energy of 12 V*50 Ah=600 Wh=0.6 kWh (kilowatt hours).

In electric cars, the capacity is in most cases indicated as the amount of energy in kilowatt hours (kWh), which, together with the consumption per 100 km (e.g. kWh), then gives the range. For example, it is possible to travel 300 km with a kWh battery if the specific consumption is 15 kWh per 100 km. In this context, the range becomes difficult to calculate if the capacity is indicated in terms of a charge (e.g. 120 Ah) and the battery voltage is not known. In order to compare different batteries on the basis of their charging capacities, it is useful if their voltages are known.

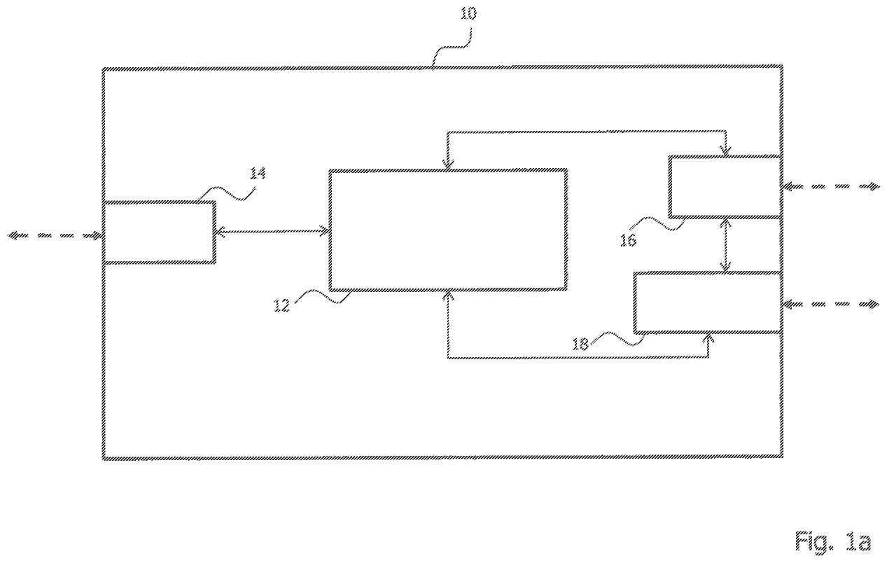

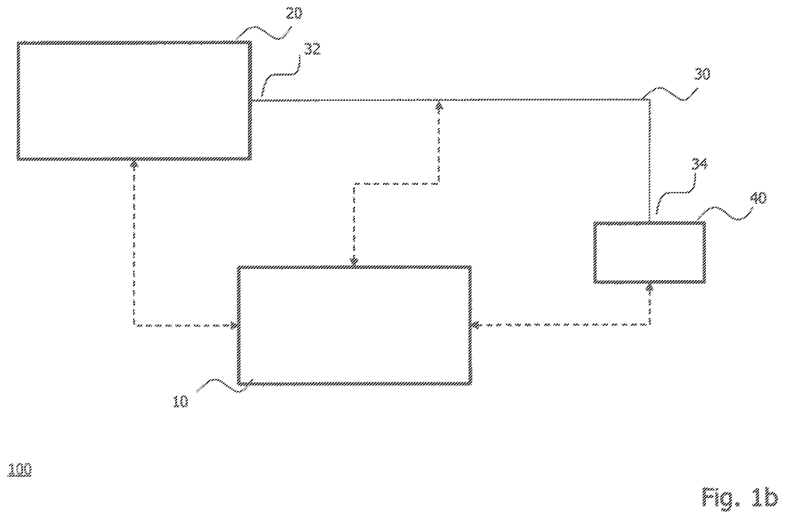

Exemplary embodiments and associated details are described in the following text. FIG. 1a shows an exemplary embodiment of a control unit 10 for controlling a charging process of electric vehicles. The control unit 10 has a first interface 14 and a processor 12. The control unit 10 can be able to be coupled, able to be connected, coupled or connected by way of the first interface 14 to a charging station 20, as is shown by way of example in FIG. 1b. The control unit 10 optionally has a second interface 16 and/or a third interface 18. The control unit 10 can be able to be coupled, able to be connected, coupled or connected by way of the second interface 16 to the charging cable 30. The control unit 10 can be able to be coupled, able to be connected, coupled or connected by way of the third interface 18 to the electric vehicle 40, for example to a battery of the electric vehicle 40.

FIG. 1b shows a charging system 100 having the control unit 10 of FIG. 1a. The charging system 100 has a charging station 20 and a charging cable 30. An electric vehicle 40 is further shown. In order to charge the electric vehicle 40, the charging station can be connected to the electric vehicle 40 by way of the charging cable 30. The control unit 10 can be connected or coupled to the charging station 20 and/or to the charging cable 30 and/or to the electric vehicle 40 in order to obtain information therefrom or in order to give or transmit control instructions thereto.

Further details of the control unit 10 and of the charging system 100 will now be described with reference to FIGS. 1a and 1b jointly.

The processor 12 is configured to instruct the charging station 20 to charge the electric vehicle 40 by way of a charging cable 30 with a charging current. An initial current value of the charging current is above a continuous current value attributed to the charging cable 30. The processor 12 is configured to determine whether a temperature associated with the charging cable 30 exceeds a maximum temperature value associated with the charging cable 30. The processor 12 is configured to instruct the charging station 20, for example by way of the first interface 14, to reduce the charging current if the temperature associated with the charging cable 30 exceeds the maximum temperature value.

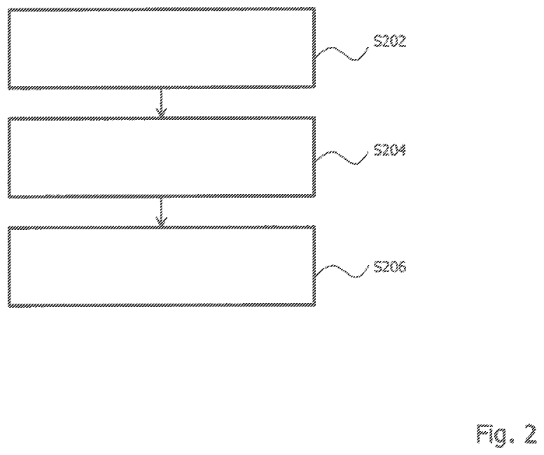

Further details of the control unit 10, of the charging system 100 and of the method will now be described with reference to FIGS. 1a, 1b and 2 jointly.

In step S202, a charging station 20 is instructed by the control unit 10, for example the processor 12, by way of the first interface 14 to charge the electric vehicle 40 by way of the charging cable 30 with a charging current. The initial current value of the charging current is above a continuous current value attributed to the charging cable 30. In step S204, the control unit 10, for example the processor 12, determines whether a temperature associated with the charging cable 30 exceeds a maximum temperature value associated with the charging cable 30. The control unit 10, for example the processor 12, can receive or determine the temperature associated with the charging cable 30 by way of the second interface 16. In step S206, the charging station 20 is instructed by the control unit, for example by the processor 12, by way of the first interface 14 to reduce the charging current if the temperature associated with the charging cable 30 exceeds the maximum temperature value.

In the following text, also with reference to further figures, details are described which can optionally be implemented in the control unit 10 of FIG. 1a, in the charging system 100 of FIG. 1b and/or in the method of FIG. 2 or which serve for the understanding thereof.

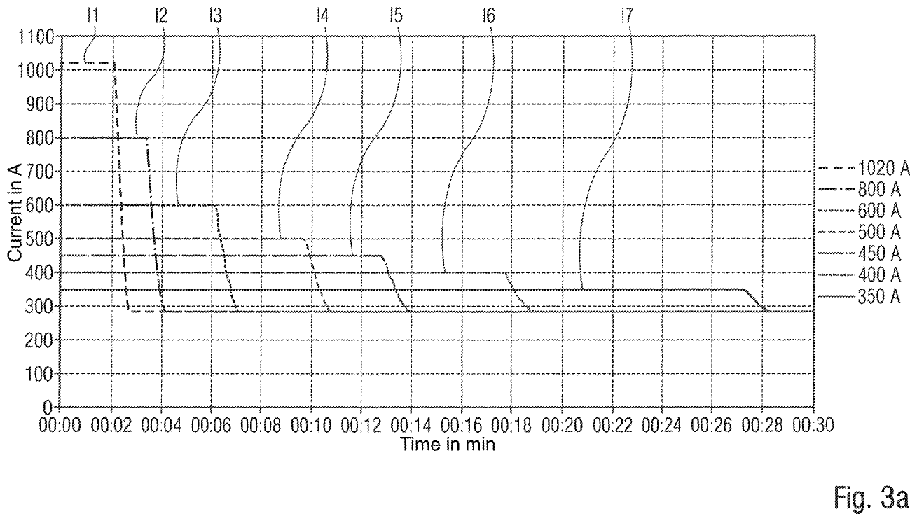

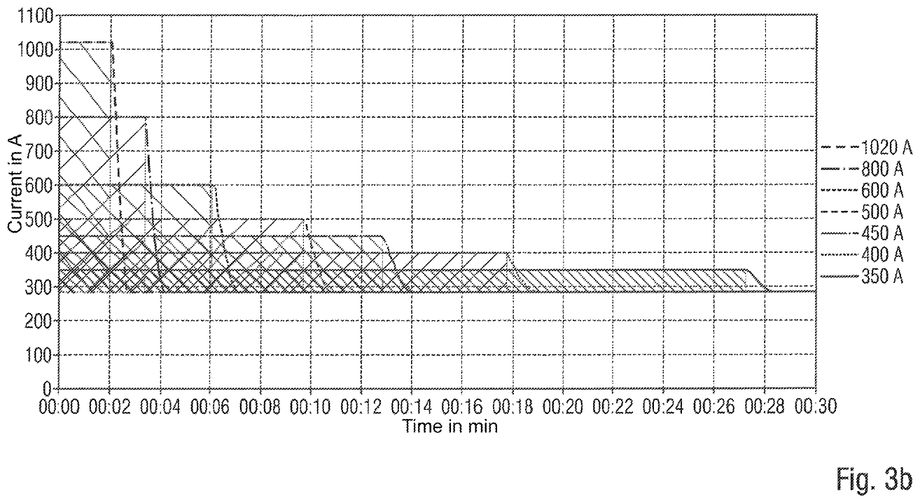

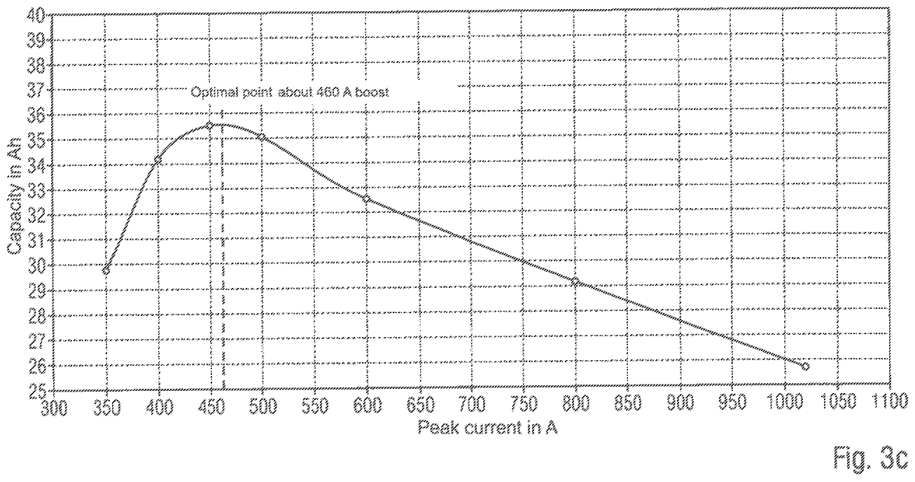

FIGS. 3a and 3b show the current profile of different currents I1 to I7 each having a different initial current value over time. In general, it can be said that the amount of electric current which can be conducted by way of electrical conductors or cables is dependent on the temperature of the conductor or cable or inside the conductor or cable. In other words, the current carrying capacity of a conductor or cable is dependent on the temperature of the conductor or cable or inside the conductor or cable. The higher the temperature of the conductor or cable or inside the conductor or cable, the lower the current carrying capacity. The lower the temperature of the conductor or cable or inside the conductor or cable, the higher the current carrying capacity. Furthermore, the higher the current flowing through a conductor or cable, the more quickly the conductor or cable heats up. The smaller the current through the conductor or cable, the more slowly the conductor or cable heats up and the longer it takes for a specific temperature as a temperature threshold value of the conductor or cable to be reached. The greater the current through the conductor or cable, the more quickly the conductor or cable heats up and the shorter the time taken for a temperature threshold value of the conductor or cable to be reached. This relationship is illustrated in FIGS. 3a and 3b by means of seven exemplary current profiles.

The seven different currents I1 to I7 each have different initial current values. Initial current values are current values which flow through the charging cable 30 in an initial state. The initial state can be a cold or cool state of the charging cable 30. In the example of FIGS. 3a and 3b, the respective initial current values for the seven charging currents I1, I2, I3, I4, I5, I6 and I7 are, for example, as follows: 1020 A, 800 A, 600 A, 500 A, 450 A, 400 A and 350 A.

In a first charging process, the control unit 10 instructs the charging station 20 by way of the first interface 14 to charge the electric vehicle 40 by way of the charging cable 30 with a charging current IL The initial current value of the charging current I1 is above a continuous current value attributed to the charging cable 30, for example determined for the charging cable 30. The continuous current nominal value is, for example, 285 A. The control unit 10 determines or receives by way of the second interface 16 information relating to a temperature associated with the charging cable 30. The processor 12 then determines whether the temperature associated with the charging cable 30 exceeds a maximum temperature value associated with the charging cable 30. There can be measured or determined as the temperature associated with the charging cable 30, for example, a temperature at the surface or a temperature in the core of the charging cable 30. Examples of values which may be mentioned here are a maximum temperature value in the core of the charging cable 30 of 90° C. and a maximum temperature value at the surface of the charging cable 30 of 60° C. In addition or alternatively, there can be measured or determined as a temperature associated with the charging cable 30 a temperature of a first plug connector 32 and/or of a second plug connector.

Owing to the charging current having a high initial current value of 1020 A, a temperature at or in the cable that reaches or exceeds the maximum temperature value at the surface and/or the maximum temperature value in the core of the charging cable 30 is reached after only about two minutes. This is recognized by the control unit 10, for example, by means of information received by the second interface 16. Because the temperature associated with the charging cable 30 reaches or exceeds the maximum temperature value, the charging station 20 is instructed by the control unit 10 by way of the first interface 14 to reduce the charging current IL In the example shown, the charging station 20 is instructed by way of the first interface 14 to reduce the charging current I1 to a value which corresponds to the continuous current of, for example, 285 A. The charging current is held at the value of the continuous current for the remainder of the charging process. The temperature of the charging cable 30 or in the charging cable thus does not increase further. Because the continuous current was exceeded for about two minutes, that is to say because a significantly higher peak current (initial current) of 1020 A was used for about two minutes, the electric vehicle 40 is charged more quickly during the first charging process than in a conventional charging process which is carried out only with the continuous current. In other words, the battery of the electric vehicle 40 is charged more quickly and/or more efficiently.

A second charging process with a charging current I2 having a lower initial current value of 800 A than in the first charging process is likewise shown in FIG. 3a. Initially, the electric vehicle 40 is charged by way of the charging cable 30 with a charging current having the initial current value of 800 A. The charging cable 30 thus heats up slightly more slowly than during the first charging process. The maximum temperature value at or in the charging cable 30 is reached during the second charging process after almost four minutes. When the maximum temperature limit value is reached or exceeded, the control unit 10 instructs the charging station 20 by way of the first interface 14 to reduce the charging current I2, for example to the continuous current of 285 A. For example, the control unit 10 instructs the charging station 20 by way of the first interface 14 to lower the charging current I2 to the continuous current of 285 A for the remainder of the charging process. Because the continuous current was exceeded for almost four minutes, that is to say for almost four minutes a significantly higher peak current (initial current) of 800 A was used than in a conventional charging process in which only the continuous current was used, the electric vehicle 40 is charged more quickly during the charging process than in such a conventional charging process. In other words, the battery of the electric vehicle 40 is charged more quickly and/or more efficiently.

A third charging process with a charging current I3 having a lower initial current value of 600 A than in the second charging process is likewise shown in FIG. 3a. Initially, the electric vehicle 40 is charged by way of the charging cable 30 with the initial current value of 600 A. The charging cable 30 thus heats up slightly more slowly than during the second charging process. The maximum temperature limit value at or in the charging cable 30 is reached in this case after a good six minutes. When the maximum temperature limit value is reached or exceeded, the control unit instructs the charging station 20 by way of the first interface 14 to reduce the charging current I3, for example to the continuous current of 285 A. For example, the control unit 10 instructs the charging station 20 to lower the charging current I3 to the continuous current of 285 A for the remainder of the charging process. Because the continuous current was exceeded for a good six minutes, that is to say for almost six minutes a significantly higher peak current (initial current) of 600 A was used than in a conventional charging process in which only the continuous current was used, the electric vehicle 40 is charged more quickly during the charging process than in such a conventional charging process. In other words, the battery of the electric vehicle 40 is charged more quickly and/or more efficiently.

A fourth charging process with a charging current I4 having a lower initial current value of 500 A than in the third charging process is likewise shown in FIG. 3a. Initially, the electric vehicle 40 is charged by way of the charging cable 30 with a charging current having the initial current value of 500 A. The charging cable 30 thus heats up slightly more slowly than during the third charging process. The maximum temperature limit value at or in the charging cable 30 is reached in the fourth charging process after almost ten minutes. When the maximum temperature limit value is reached or exceeded, the control unit 10 instructs the charging station 20 by way of the first interface 14 to reduce the charging current I4, for example to the continuous current of 285 A. For example, the control unit 10 instructs the charging station 20 by way of the first interface 14 to lower the charging current I4 to the continuous current of 285 A for the remainder of the charging process. Because the continuous current was exceeded for almost ten minutes, that is to say for almost ten minutes a significantly higher peak current (initial current) of 500 A was used than in a conventional charging process in which only the continuous current was used for charging, the electric vehicle 40 is charged more quickly during the charging process than in such a conventional charging process. In other words, the battery of the electric vehicle 40 is charged more quickly and/or more efficiently.

A fifth charging process with a charging current I5 having a lower initial current value of 450 A than in the fourth charging process is likewise shown in FIG. 3a. Initially, the electric vehicle 40 is charged by way of the charging cable 30 with a charging current having the initial current value of 450 A. The charging cable 30 thus heats up slightly more slowly than during the fourth charging process. The maximum temperature limit value at or in the charging cable 30 is reached in the fifth charging process after about thirteen minutes. When the maximum temperature limit value is reached or exceeded, the control unit 10 instructs the charging station 20 by way of the first interface 14 to reduce the charging current I5, for example to the continuous current of 285 A. For example, the control unit 10 instructs the charging station 20 by way of the first interface 14 to lower the charging current I5 to the continuous current of 285 A for the remainder of the charging process. Because the continuous current was exceeded for about thirteen minutes, that is to say for almost thirteen minutes a higher peak current (initial current) of 450 A was used than in a conventional charging process in which only the continuous current was used for charging, the electric vehicle 40 is charged more quickly during the charging process than in such a conventional charging process. In other words, the battery of the electric vehicle 40 is charged more quickly and/or more efficiently.

A sixth charging process with a charging current I6 having a lower initial current value of 400 A than in the fifth charging process is likewise shown in FIG. 3a. Initially, the electric vehicle 40 is charged by way of the charging cable 30 with a charging current having the initial current value of 400 A. The charging cable 30 thus heats up slightly more slowly than during the fifth charging process. The maximum temperature limit value at or in the charging cable 30 is reached in this case after almost eighteen minutes. When the maximum temperature limit value is reached or exceeded, the control unit 10 instructs the charging station 20 by way of the first interface 14 to reduce the charging current I6, for example to the continuous current of 285 A. For example, the control unit 10 instructs the charging station 20 by way of the first interface 14 to lower the charging current I6 to the continuous current of 285 A for the remainder of the charging process. Because the continuous current was exceeded for almost eighteen minutes, that is to say for almost eighteen minutes a higher peak current (initial current) of 400 A was used than in a conventional charging process in which only the continuous current was used for charging, the electric vehicle 40 is charged more quickly during the charging process than in such a conventional charging process. In other words, the battery of the electric vehicle 40 is charged more quickly and/or more efficiently.

A seventh charging process with a charging current I7 having a lower initial current value of 350 A than in the sixth charging process is likewise shown in FIG. 3a. Initially, the electric vehicle 40 is charged by way of the charging cable 30 with a charging current having the initial current value of 350 A. The charging cable 30 thus heats up slightly more slowly than in the preceding example. The maximum temperature limit value at or in the charging cable 30 is reached in this case after a good twenty-seven minutes. When the maximum temperature limit value is reached or exceeded, the control unit 10 instructs the charging station 20 to reduce the charging current I7, for example to the continuous current of 285 A. For example, the control unit 10 instructs the charging station 20 to lower the charging current I7 to the continuous current of 285 A for the remainder of the charging process. Because the continuous current was exceeded for a good twenty-seven minutes, that is to say for almost twenty-seven minutes a higher peak current (initial current) of 350 A was used than in a conventional charging process in which only the continuous current was used for charging, the electric vehicle 40 is charged more quickly during the charging process than in such a conventional charging process. In other words, the battery of the electric vehicle 40 is charged more quickly and/or more efficiently.

In FIG. 3b, the areas in the respective regions that are bounded by the initial current and the continuous current as well as by the respective time period can be seen. The area present in each case is obtained by multiplying the current difference between the initial current and the continuous current by the length of time for which this current difference between the initial current and the continuous current persisted. The areas each indicate, as it were, the capacity of the battery with which the battery could additionally be charged compared to a conventional charging process using only continuous current. It is apparent from FIG. 3b that an increase in efficiency is achieved for all the currents I1 to I7. A particularly great increase in efficiency is achieved for initial current values between about 400 A and 600 A.

FIG. 3c shows the capacity, in Ah, which is achieved with different currents I1 to I7 having the different initial currents/peak currents from FIGS. 3a and 3b. Here too, it is apparent that increases in efficiency are achieved for all the currents I1 to I7. Particularly high increases in efficiency are achieved for initial currents/peak currents in the range of from 400 A to 550 A. The highest increases in efficiency are achieved for initial currents/peak currents in the range of about 420 A and 500 A. A maximum value for the capacity is obtained in the case of a current having an initial current value of 460 A. The terms initial current and peak current can be considered equivalent in the example shown since, because a conductor heats up when current flows through it and the current carrying capacity of the conductor is thus reduced, the initial current usually corresponds to the peak current.

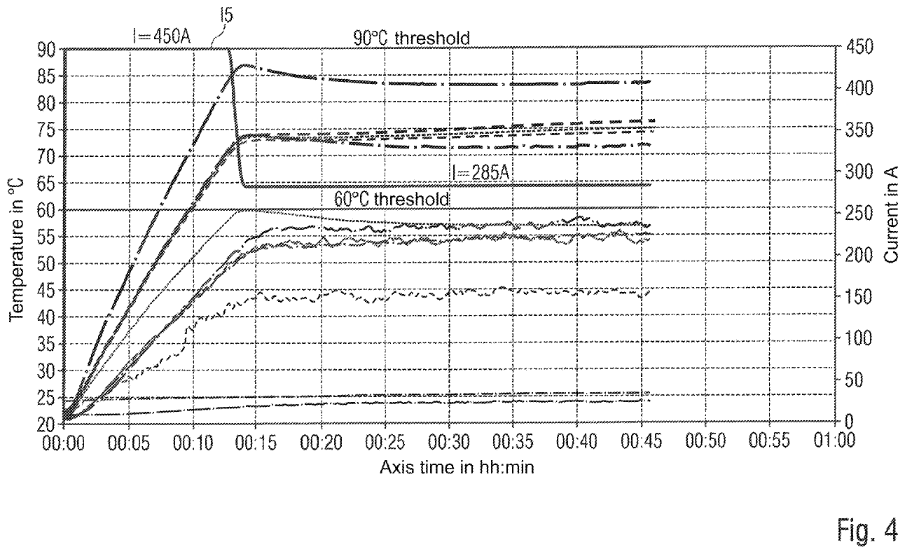

FIG. 4 shows a profile of a charging current I5 during a charging process. Different temperature profiles under different conditions and/or with different lines or cables are also shown. For example, before a charging process, a user chooses, at a charging station 20 or at a portable or other interface, that an electric vehicle 40 is to be charged as quickly as possible or to as high a capacity as possible. Therefore, a control unit 10 selects or determines a charging current I5 having an initial value from FIGS. 3a to 3c with which as high a capacity is possible is achieved. For example, an initial current value of 450 A is chosen by the control unit 10. As can be seen, a temperature limit value for the surface of the charging cable 30, namely, for example, a temperature limit value of 60° C. at the surface of the charging cable 30, is reached after about thirteen minutes. The control unit 10 then instructs the charging station 20 to reduce the charging current I5. For example, the charging current is reduced to the continuous current of the charging cable 30 of, for example, 285 A. The continuous current is maintained for the remainder of the charging process. According to the exemplary configuration for a charging process that is described in relation to FIG. 4, it is attempted to charge the battery as quickly as possible, for example fully. The time period to the end of the charging process can here be variable.

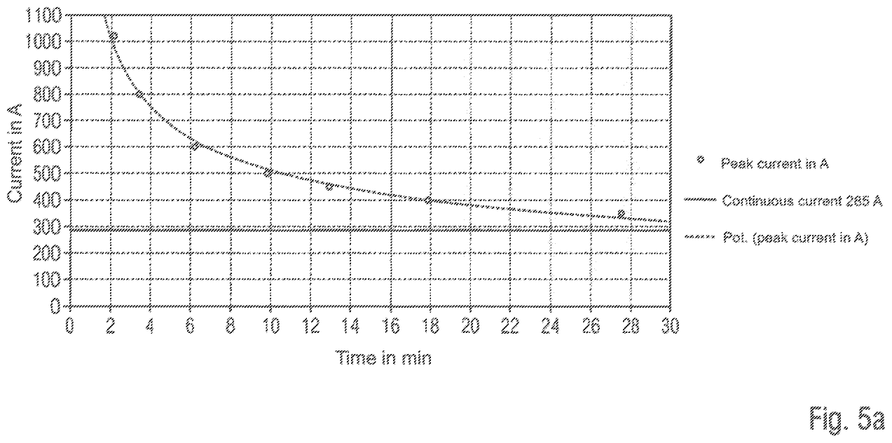

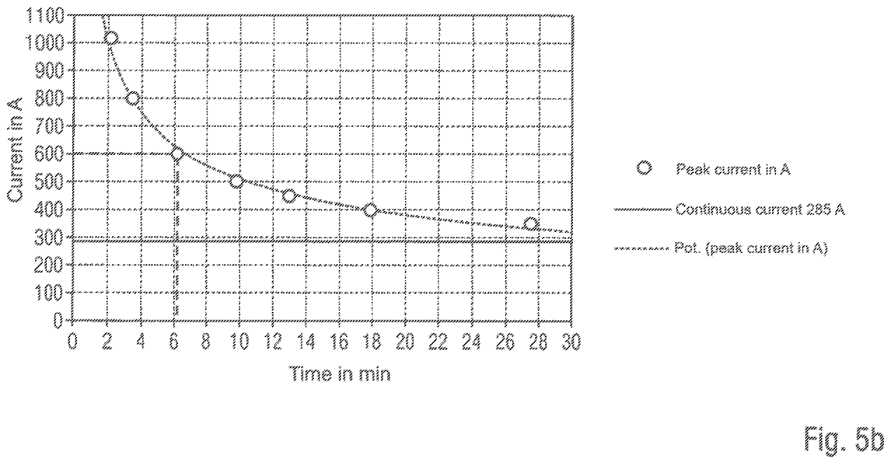

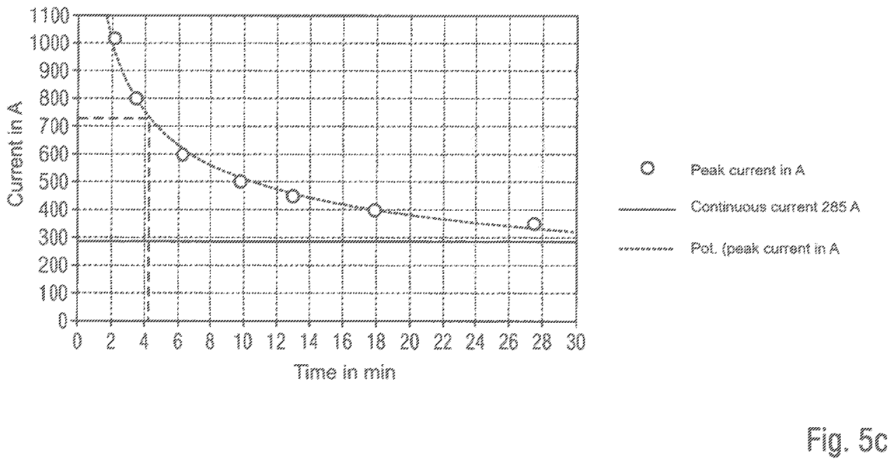

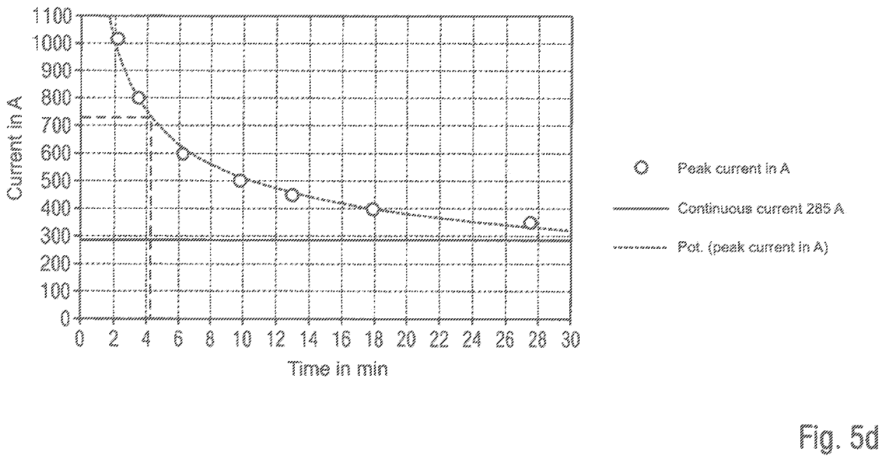

In FIGS. 5a to 5d, a fixed time period for the charging process is chosen. By contrast, the result of the charging process, namely the capacity that is achieved, is variable. In this connection, FIGS. 5a to 5d show an ideal initial current (peak current) for a chosen charging time period. That is to say, if a charging time period of two minutes is chosen, for example, the control unit 10 determines an ideal initial current of about 1000 A. If a charging time period of four minutes is chosen, an ideal initial current of about 750 A is determined. A charging time period of six minutes gives an initial current of almost 650 A, a charging time period of ten minutes gives an initial current of a good 500 A, etc.

Concrete examples will now be described with reference to FIGS. 5a to 5d.

According to a first example, a first electric vehicle is to be charged. The first electric vehicle has, for example, a battery capacity of 95 kWh gross and 86.5 kWh net. The battery of the first vehicle has, for example, a state of charge (SoC) of 30%. The SoC value is a characteristic value for the charge level of rechargeable batteries. The SoC value characterizes the available capacity of a rechargeable battery in relation to the nominal value. The charge level is indicated in percent of the fully charged state. 30% thus means that the rechargeable battery still has a residual charge of 30% based on the full charge of 100%. The battery voltage of the battery of the first vehicle is, for example, 396 V. The capacity is thus 175 Ah.

The user then chooses and/or the vehicle determines and/or a higher-level entity determines that only six minutes are available for the charging process. For example, the user knows that he will make only a short stop at the charging station 20 in order to get some fresh air or something to drink. Or it is known to the vehicle 40 that the driver, owing to the duration of the journey thus far, must make a short stop but, for example, only six minutes are free and/or reservable at the charging station 20 at the desired arrival time. The required fixed charging time is thus six minutes. The control unit 10 then receives, for example, information about the charging time period, which indicates that the charging time period is six minutes. On the basis of the known characteristic curve (see FIG. 4b), the control unit 10 chooses an ideal initial current value of 600 A (for a charging time of six minutes) for the first vehicle. The ideal initial current value is the current value with which the greatest charging capacity is achieved in the predefined charging time period of six minutes. Although charging would initially take place more quickly with a higher initial current value of, for example, 1000 A, the temperature limit value of the charging cable 30 would be reached more quickly with the higher initial current value of, for example, 1000 A, namely in the case shown in significantly less than six minutes. This would have the result that, although charging initially takes place more quickly, the initial current value would be reduced by the control unit 10 to the continuous current value after only a few minutes. By contrast, if 600 A is used as the initial current value, there is ideally no reduction or only a brief reduction of the charging current within the six minutes during the charging process.

In other words, the control unit 10 calculates 600 A as the ideal initial current in the case of a fixed charging time of six minutes in order to charge or reach as high a battery capacity as possible within six minutes. For the concrete example, this means that, using a continuous current of 285 A, an amount of energy of 11.3 kWh would be charged within six minutes. For the first vehicle, this corresponds, for example, to a range of about 45 km. By contrast, using an initial current value of 600 A for a charging process of six minutes, an amount of energy of 23.8 kWh is charged. For the first vehicle, this corresponds to a range of about 95 km. Compared to the normal charging process with continuous current, an improvement of 12.5 kWh or 50 km range or 110% is therefore achieved by means of the proposed solution.

According to a second example, the first electric vehicle is again to be charged. However, the user chooses and/or the vehicle determines and/or a higher-level entity determines that only four minutes are available for the charging process. For example, the user knows that he will make only a short stop in order to get some fresh air or something to drink. Or it is known to the vehicle that the driver, owing to the duration of the journey thus far, must make a short stop but, for example, only four minutes are free and/or reservable at a charging station 20 at the desired arrival time. The required fixed charging time is thus four minutes. The control unit 10 in any case receives or determines information about the charging time period, which indicates that the fixed charging time period is four minutes. On the basis of the known characteristic curve (FIG. 4c), the control unit 10 chooses an ideal initial current value of 740 A for the first vehicle. The ideal initial current value is the current value with which the greatest charging capacity is achieved in the predefined, fixed charging time period of four minutes. Although charging would initially take place more quickly with a higher initial current value of, for example, 1000 A, the temperature limit value of the charging cable 30 would be reached more quickly with the higher initial current value of, for example, 1000 A, namely in the case shown in significantly less than four minutes. This has the result that, although charging would initially take place more quickly, the initial current value would be reduced by the charging station 20 on instruction of the control unit 10 to the continuous current value after only a few minutes. By contrast, if 740 A is used as the initial current value, there is ideally no reduction or only a brief reduction of the charging current within the four minutes during the charging process.

That is to say, the control unit 10 calculates 740 A as the ideal initial current in the case of a fixed charging time of four minutes in order to charge as much battery capacity/as large an amount of energy as possible within four minutes. For the concrete example, this means that, using a continuous current of 285 A, an amount of energy of 7.5 kWh would be charged within four minutes. For the first vehicle, this corresponds, for example, to a range of about 30 km. By contrast, using an initial current value of 740 A for a charging process of a fixed duration of four minutes, an amount of energy of 19.5 kWh is charged. For the first vehicle, this corresponds to a range of about 78 km. Compared to the normal charging process with continuous current, an improvement of 12 kWh or 48 km range or 160% is achieved by means of the proposed solution.

According to a third example, a second electric vehicle is to be charged. The second electric vehicle has, for example, a battery capacity of 93.4 kWh gross and 83.7 kWh net. The battery of the second vehicle has, for example, a state of charge (SoC) of 30%. The battery voltage of the battery of the second vehicle is, for example, 800 V. The capacity is thus 104.6 Ah.

However, the user chooses and/or the vehicle determines and/or a higher-level entity determines that only a fixed time of four minutes is available for the charging process. For example, the user knows that he will make only a short stop in order to get some fresh air or something to drink. Or it is known to the vehicle that the driver, owing to the duration of the journey thus far, must make a short stop but, for example, only four minutes are free and/or reservable at a charging station 20 at the desired arrival time. The required fixed charging time is thus four minutes. The control unit 10 receives information about the fixed charging time period, which indicates that the charging time period is four minutes. On the basis of the known characteristic curve for the second vehicle (FIG. 4d), the control unit 10 chooses an ideal initial current value of 740 A. The ideal initial current value is the current value with which the greatest charging capacity is achieved in the predefined charging time period of four minutes. Although charging would initially take place more quickly with a higher initial current value of, for example, 1000 A, the temperature limit value of the charging cable 30 would be reached more quickly with the higher initial current value of, for example, 1000 A, namely in the case shown in significantly less than four minutes. This would have the result that, although charging would initially take place more quickly, the initial current value would have to be reduced to the continuous current value after only a few minutes. By contrast, if 740 A is used as the initial current value, there is ideally no reduction or only a brief reduction of the charging current within the four minutes.

That is to say, the control unit 10 calculates 740 A as the ideal initial current in the case of four minutes in order to charge as much battery capacity/as large an amount of energy as possible within four minutes. For the concrete example, this means that, using a continuous current of 285 A, an amount of energy of 15.2 kWh would be charged within four minutes. For the second vehicle, this corresponds, for example, to a range of 56 km. Using an initial current value of 740 A for a charging process of four minutes, an amount of energy of 39.5 kWh is charged. For the second vehicle, this corresponds to a range of 146 km. Compared to the normal charging process with continuous current, an improvement of 24.3 kWh or 90 km range or 160% is achieved by means of the method that is presented.

Sensors (not shown), for example one or more temperature sensors, can additionally be inserted in the charging cable 30 according to each of the three examples. This simplifies and/or improves the temperature monitoring of the charging cable 30, since the temperature can be measured directly in the charging cable 30. The measured temperature can then be received or accessed by the control unit by way of the second interface 16.

Without the implementation presented, the surface temperature of the charging line would rise above the limit value of IEC 117 at high charging currents and potentially lead to injury to the user when touching/handling the cable. The thermal energy that occurs during charging is, as described herein, reduced by skillful and/or intelligent reduction of the charging current. Otherwise, the maximum permissible conductor temperature according to EN 50620 or IEC 62893 would be exceeded after a certain time. The lines could thus be damaged in terms of their service life.

In some cases, it is proposed in the prior art to monitor a temperature of contacts of the charging system. This temperature monitoring is based on the normative limit of 90° C. of DC contacts in charging systems according to IEC 62196. Temperature monitoring of the so-called DC pins can be used, for example, in high power charging (HPC) or combined charging system (CCS) plugs and vehicle inlets.

In some cases, the contact temperature in the charging system is monitored in the prior art. For example, by way of a controller area network (CAN) or a controller of a CAN between plug and charging point, a flag can be set at a temperature of 80° C. and above, which requires the charging point to reduce the current. At a temperature of 90° C. and above, the charging point is, for example, ordered to cut off the current.

1. A method for controlling a charging process of electric vehicles, comprising:
instructing a charging station to charge an electric vehicle by way of a charging cable with a charging current, wherein an initial current value of the charging current is above a continuous current value attributed to the charging cable;
determining whether a temperature associated with the charging cable reaches or exceeds a maximum temperature value associated with the charging cable; and
instructing the charging station to reduce the charging current if the temperature associated with the charging cable reaches or exceeds the maximum temperature value.

2. The method as claimed in claim 1, wherein the method further comprises instructing the charging station to reduce the charging current to a value corresponding at the maximum to the continuous current if the temperature associated with the charging cable-reaches or exceeds the maximum temperature value.

3. The method as claimed in claim 1, wherein the method further comprises instructing the charging station to maintain the charging current at a value above the continuous current if the temperature associated with the charging cable does not reach or does not exceed the maximum temperature value.

4. The method as claimed in claim 1, wherein the method further comprises receiving information relating to a capacity to be charged of a battery to be charged of the electric vehicle and determining the initial current value of the charging current taking account of the capacity of the battery to be charged.

5. The method as claimed in claim 1, wherein the method further comprises receiving information relating to a time period for at least partial charging of a battery to be charged of the electric vehicle and determining the initial current value of the charging current taking account of the time period for at least partial charging of the battery to be charged.

6. A control unit for controlling a charging process of electric vehicles, having:
a first interface by way of which the control unit is able to be connected or is connected to a charging station; and
a processor which is configured:
to instruct the charging station to charge an electric vehicle by way of a charging cable with a charging current, wherein an initial current value of the charging current is above a continuous current value attributed to the charging cable;
to determine whether a temperature associated with the charging cable reaches or exceeds a maximum temperature value associated with the charging cable; and
to instruct the charging station to reduce the charging current if the temperature associated with the charging cable reaches or exceeds the maximum temperature value.

7. The control unit as claimed in claim 6, wherein the processor is further configured to instruct the charging station to reduce the charging current to a value corresponding at the maximum to the continuous current if the temperature associated with the charging cable reaches or exceeds the maximum temperature value.

8. The control unit as claimed in claim 6, wherein the processor is further configured to instruct the charging station to maintain the charging current at a value above the continuous current if the temperature associated with the charging cable does not reach or does not exceed the maximum temperature value.

9. The control unit as claimed in claim 6, further having a second interface which is configured to receive or to determine the temperature associated with the charging cable.

10. The control unit as claimed in claim 6, further having a third interface which is configured:
to receive information relating to a capacity to be charged of a battery to be charged of the electric vehicle, wherein the processor is further configured to determine the initial current value of the charging current taking account of the capacity of the battery to be charged; and/or
to receive information relating to a time period for at least partial charging of a battery to be charged of the electric vehicle, wherein the processor is configured to determine the initial current value of the charging current taking account of the time period for at least partial charging of the battery to be charged.

11. A charging system for carrying out a charging process of electric vehicles, having:
a charging station,
a charging cable by way of which the charging station is able to be connected or is connected to an electric vehicle; and
a control unit as claimed in claim 6.
